(19) United States
(12) Patent Application Publication
(10) Pub. No.: US 2012/0057121 A1
(43) Pub. Date: Mar. 8, 2012

(54) ORTHOKERATOLOGY LENS WEAR COMBINED WITH CHEMICAL TREATMENT TO CORRECT MYOPIA, HYPEROPIA OR ASTIGMATISM

(76) Inventors: Bruce H. Dewoolfson, Vienna, VA (US); Dale P. Devore, Chelmsford, MA (US); Braden Devore, Chelmsford, MA (US); George E. Glady, Oak Hills, VA (US); Gabriel Carpio, Chula Vista, CA (US); Donald H. Harris, Newport Beach, CA (US)

(21) Appl. No.: 13/203,698

(22) PCT Filed: Feb. 23, 2010
(86) PCT No.: PCT/US10/25036

§ 371 Date: Nov. 23, 2011

Related U.S. Application Data
(60) Provisional application No. 61/156,012, filed on Feb. 27, 2009.

(51) Int. Cl. G02C 7/04

(52) U.S. Cl. 351/160 R

(57) ABSTRACT

Methods of treating a refractive error of the eye are disclosed comprising applying a treatment that induces swelling of the corneal tissue and applying an orthokeratology lens configured to correct the refractive error that provides a controlled distribution of the corneal tissue.

This application claims priority to U.S. Provisional Application No. 61/156,012 filed Feb. 27, 2009, the contents of which are incorporated herein by reference.

### FIELD OF THE INVENTION

The present invention relates to methods of correcting or treating myopia, hyperopia, and astigmatism by the temporary wear of individually designed orthokeratology lenses in combination with controlled chemical acylation of specific corneal regions to increase corneal thickness in these predetermined areas.

### BACKGROUND

### Structure and Composition of a Human Cornea:

The cornea is the first and most powerful refracting surface of the optical system of the eye. Production of a sharp image at the retinal receptors requires that the cornea be transparent and of appropriate refractive power. The refractive power of the cornea depends primarily on two factors: its curvature and its refractive index. When the cornea is misshapened or the axial length of the eye is too long or short, or the lens of the eye is functioning abnormally, various vision related problems, such as myopia, astigmatism, hyperopia, or the like, can result. Eyeglasses or contact lenses are necessary to correct the problems. Eyeglasses accommodate the refractive errors by refracting the light with a lens before it reaches the cornea and to change the angle at which light enters the cornea. Contact lenses accommodate refractive errors of the eye by replacing the misshapened cornea with a front curve of a contact lens which is calculated to render the eye emmetropic. When the lens is taken off, however, the cornea is still misshapened or defective and refractive errors still remain.

The cornea contains 75% to 80% water on a wet weight basis. Of the remaining 20% to 25% solids, most are collagen, or other proteins, and glycosaminoglycans. Corneal fibrils, which form the skeleton of the corneal stroma, are neatly organized and present the typical 64 to 66 nm periodicity of collagen. The physicochemical properties of corneal collagen, however, do not significantly differ from those of tendon and skin collagen. Like collagen from these other sources, corneal collagen has high nitrogen, glycine, proline, and hydroxyproline contents. In boiling water or acid, corneal collagen is converted to gelatin, and collagen can be dissolved by proteolytic enzymes such as collagenase, pepsin, or papain.

### Orthokeratology Lens Wear:

Orthokeratology is a nonsurgical procedure to improve refractive errors of the eye, and is an alternative to, e.g., laser eye surgery. Specifically, orthokeratology is a therapeutic procedure to reshape the curvature of a patient's cornea. A conventional orthokeratology procedure involves the use of a series of progressive contact lenses that are intended to gradually reshape the cornea and produce a more spherical anterior curvature. The process typically involves the fitting of two to as many as several pairs of specially designed contact lenses, and it has traditionally taken approximately three to six months to achieve optical reshaping. This procedure has been proven to temporarily reduce or eliminate myopia and astigmatism, hence improving natural vision and producing emmetropia (a state where vision experiences zero refractive error, or where no correction is necessary). Recent improvements in orthokeratology lens designs make it possible to achieve emmetropia much more rapidly. In many cases, this may be accomplished with a single night's wear of a single pair of end result lenses. Orthokeratology lenses provide an ideal method of redistributing chemically treated corneal tissues to achieve temporary desired correction of myopia, hyperopia and astigmatism.

DeVore and DeVore (US2005/0106270) describe the application of specific acylation agents to predetermined regions of the cornea to place water binding moieties on amino acids with less water binding capacity. This increased in hydration resulted in an increase in corneal thickness in the predetermined regions. The application of an individually designed orthokeratologic lens provides controlled redistribution of the treated tissue for temporary correction of myopia, hyperopia and astigmatism. The application of designed orthokeratology lenses following chemical treatments described in US2005/0106270 will provide controlled redistribution of treated corneal tissues; for myopia treated tissue is pushed to the periphery of the cornea thereby providing controlled central cornea flattening; for hyperopia treated tissues are organized in the central cornea region to provide controlled steepening of the central cornea; for astigmatism controlled regions of the cornea are treated with acylation agents to increase hydration and then molded in place using designed orthokeratologic lenses.

It is known that various chemical agents will react with proteins to alter their chemical and physical characteristics. Generally, these chemical agents are used to modify proteins in solution. Several reviews discussing chemical modification are available including Chemical Reagents for Protein Modification, Ed. R L Lunblad, CRC Press, Boca Raton, 1991 and G R Stark, Recent developments in chemical modification and sequential degradation of proteins, Advances in Protein Chemistry, 24: 261-308, 1970. Specific chemical agents react with deprotonated free amines on proteins to replace the positive (NH₃⁺) charge with a chemical moiety exhibiting a negative charge or neutral charge. Other chemical agents react with deprotonated amines on proteins to replace a single positive (NH₃⁺) charge with two positive charges (NH₃⁺×2). This change in net charge and charge density alters both the chemical and physical characteristics of the protein.

Acylation reactions have commonly been used to derivatize soluble and insoluble collagen and have been described by DeVore, et al. in a series of patents (U.S. Pat. Nos. 4,713,446, 4,851,513, 4,969,912, 5,067,961, 5,104,957, 5,201,764, 5,219,895, 5,332,809, 5,354,336, 5,476,515, 5,480,427, 5,631,243, and 6,161,544). An increase in net negative charge density will increase water binding resulting in tissue swelling. A decrease in net negative charge will decrease water binding. Changes in net charge density also have dramatic effects on mechanical properties of treated tissues.

It is known that orthokeratology lenses are effective in temporary redistribution of cornea tissue to correct myopia, hyperopia, and astigmatism. It is also known that specific chemical agents can be applied to corneal tissues to cause somewhat controlled increases in corneal thickness. In the present invention, orthokeratology lenses are applied to the human eye before, during, or following acylation treatments.

### SUMMARY OF THE INVENTION

The inventors have discovered that orthokeratology lens wear can achieve accurate redistribution of corneal tissue following chemical treatment of corneal tissue to achieve regional increases in corneal thickness due to enhanced hydration provides a novel technique for rapid and long-term correction of myopia, hyperopia, and astigmatism.

For example, selective chemical treatment of the peripheral circumference of the human cornea results in swelling of this region causing flattening of the central corneal area, thereby providing correction of myopia. Selective chemical treatment of the central cornea results in swelling of the central cornea resulting in steepening of this region, thereby providing correction of hyperopia. The combination of chemical treatment with temporary wear of specifically designed orthokeratology lenses provides an exact curvature fitting the individually fabricated orthokeratologic lens configuration.

Thus, in one embodiment the invention comprises a method of treating the refractive error of an eye, comprising:

a first step comprising placing a treatment device on the cornea of the eye, wherein the treatment device is configured to control the area of application of a treatment to corneal tissues of the eye;

a second step comprising applying to the corneal tissues a treatment that induces swelling of the corneal tissues in the area determined by the treatment device;

a third step comprising removing the treatment device; and

a fourth step comprising placing an orthokeratology lens that has been configured to correct the refractive error and, optionally, any additional optical errors, of the corneal tissues on the cornea to provide a controlled redistribution of the treated corneal tissues; thereby treating the refractive error of the eye.

In some embodiments, the method further comprises placing an orthokeratology lens on the cornea for a period of time sufficient to improve the refractive error of the eye and removing the orthokeratology lens during placement of the treatment device on the cornea. In other embodiments, the eye has not been treated with an orthokeratology lens prior to the placement of the treatment device. In many embodiments, the treatment comprises first applying a buffer solution for a period of time sufficient to bring the pH of the corneal tissue to between pH 7.5 and 9.5 and second applying an acylation reagent.

In those embodiments in which the eye is myopic, the treatment device generally is configured to control the application of the treatment to the periphery of the corneal tissues of the eye.

In those embodiments in which the eye is hyperopic, the treatment device is generally configured to control the application of the treatment to the central area of the corneal tissues of the eye.

In those embodiments in which the eye is astigmatic, the treatment device is generally configured to control the application of the treatment to those areas of the corneal tissue that have refractive errors or other optical errors.

In another embodiment, the invention provides a method of treating the refractive error of an eye, comprising

placing on the cornea an orthokeratology lens that has been configured to correct the refractive error and, optionally, any additional optical errors, of the corneal tissues, wherein the orthokeratology lens comprises a septum that permits access to the corneal tissues without removal of the lens;

applying through the septum of the orthokeratology lens a first treatment to the corneal tissues, wherein the first treatment comprises a buffer solution to adjust the pH of the corneal tissue to between pH 7.5 and 9.5; and

applying through the septum of the orthokeratology lens a second treatment to the corneal tissues, wherein the second treatment comprises an acylation reagent that induces swelling of the corneal tissues; thereby treating the refractive error of the eye.

In these embodiments, the eye is generally either hyperopic, astigmatic, or both.

In still other embodiments, the invention provides a method of treating the refractive error of an eye, comprising:

applying to the corneal tissues a treatment that induces swelling of the corneal tissues; and

placing an orthokeratology lens that has been configured to correct the refractive error and, optionally, any additional optical errors, of the corneal tissues on the cornea to provide a controlled redistribution of the treated corneal tissues; thereby treating the refractive error of the eye.

In these embodiments, the eye may be either myopic, hyperopic, astigmatic, or combination of these.

In the various embodiments of the invention, the acylation reagent is often selected from the group consisting of sulfonic acids, anhydrides, sulfonyl chlorides, and acid chlorides. In many embodiments, the acylation reagent is glutaric anhydride.

### BRIEF DESCRIPTION OF THE DRAWINGS

FIG. 1 depicts the four zones of an orthokeratology lens.

FIG. 2 illustrates the alignment curve zone of the lens.

FIG. 3 illustrates the peripheral curve zone of the lens

FIG. 4 illustrates the base curve zone of the lens.

FIG. 5 illustrates the relationship of the base curve and alignment curve.

FIG. 6 shows how the base curve and alignment curve can be used to calculate the fitting curve radius.

FIG. 7 illustrates a lens in which the fitting curve has been determined.

### DETAILED DESCRIPTION

Additional objects and advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed. In order that the present invention may be more readily understood, certain terms are first defined. Other definitions are set forth throughout the description of the embodiments.

By acylating agent is meant an agent that transfers an acyl group to another nucleophile. Examples of acylation agents include sulfonic acids, anhydrides, sulfonyl chlorides, and acid chlorides. A listing of appropriate anhydrides, acid chlorides, sulfonyl chlorides, and sulfonic acids can be found in the Sigma-Aldrich Chemical company catalogue.

Superficial surface is meant to be the very top layer of tissues, to depths of about 2 to 50 microns.

Orthokeratology is the use of rigid gas-permeable contact lenses, normally worn only at night, to improve vision through the reshaping of the cornea.

An Orthokeratology lens is a made to order contact lens that when worn at night will reshape the cornea according to the visual requirements of the individual patient.

US2005/0106270 demonstrated that acylation of intact tissue using specific agents can increase the net negative charge density resulting in an increase in tissue thickness and an increase in both low and high modulus measured from stress-stain analysis. Increased modulus readings relate to increased stiffness of treated tissues resulting in more force required to compress the treated tissues.

The present invention provides methods for applying designed orthokeratology lenses to human cornea that has been selectively treated in a controlled manner to alter the net charge and net charge density of reacted tissues and tissue surfaces. For example, methods within the invention can include the steps of (1) applying a treatment device to the tissue surface such that the desired area of the tissue surface is exposed to treatment solutions; (2) pretreating the exposed tissue surface with slightly alkaline buffer solution for 1-2 minutes to bring the pH of the tissue surface to between 7.5 and 9.5 resulting in deprotonation of c-amino groups of lysine residues on exposed proteins; (3) removing the pretreatment buffer solution using an absorbent sponge; (4) applying the chemical agent (e.g., an acylating agent in the same slightly alkaline buffer used in the pretreatment solution) to the exposed area such that the chemical agent immediately reacts with the exposed, pretreated tissue surface resulting in covalent bonding of the pendant chemical moiety to the deprotonated ε-amino groups of lysine residues on exposed proteins; (5) thorough rinsing of the total tissue surface to remove unreacted chemical agent and masking the deprotonated free amino group with the desired pendant group to alter the net charge and the net charge density of the treated tissue.

Specific chemicals are applied to specific regions of the cornea to increase the net negative charge on corneal tissue proteins. Chemicals capable to achieving this result include classes of sulfonic acids, anhydrides, sulfonyl chlorides, and acid chlorides. These compounds are commonly known as acylation reagents.

Agents that increase the net negative charge include, but are not limited to anhydrides including maleic anhydride, succinic anhydride, glutaric anhydride, citractonic anhydride, methyl succinic anhydride, itaconic anhydride, methyl glutaric anhydride, dimethyl glutaric anhydride, phthalic anhydride, and many other such anhydrides. Acid chlorides include, but are not limited to, oxalyl chloride, malonyl chloride, and many others. Sulfonyl chlorides include, but are not limited to, chlorosulfonylacetyl chloride, chlorosulfonylbenzoic acid, 4-chloro-3-(chlorosulfonyl)-5-nitrobenzoic acid, 3-(chlorosulfonyl)-P-anisic acid, and others. Sulfonic acid includes, but is not limited to, 3-sulfobenzoic acid and others.

Certain agents can also change the net charge from one positive to two negatives per reacted site. Specific agents include, but are not limited to, 3,5-dicarboxybenzenesulfonyl chloride and others.

In general, the concentrations of the acylation agents can range from 0.1 μg/mL to 100 mg/mL, and the concentration will depend upon the particular acylating agent. In many embodiments, the concentration is between 0.2 μg/mL and 50 mg/mL, or between 1 μg/mL and 10 mg/mL, or even between 0.5 μg/mL and 5 mg/mL. Other concentrations are set forth in the disclosure, including the Examples.

Once the net charge is altered in specific regions of the cornea, designed orthokeratology lenses can be applied to achieve controlled redistribution of cornea tissue to provide correction of myopia, hyperopia, or astigmatism.

In many embodiments, the tissue is pretreated with a solution exhibiting a pH from 7.5-9.5 prior to addition of the acylating reagent. The solution may be composed of a single component, such as disodium phosphate or sodium pyrophosphate or sodium borate, or may be a buffer composition providing a pH ranging from 7.5-9.5. The concentration of the alkaline solution generally ranges from 0.01 M to 0.2 M, but the concentration is not generally critical unless specifically so indicated. Particular concentrations for specific buffers are given elsewhere in the disclosure, such as in the Examples.

### Ortho-k Lens Custom Design and Fabrication:

### Definition of Curve Widths

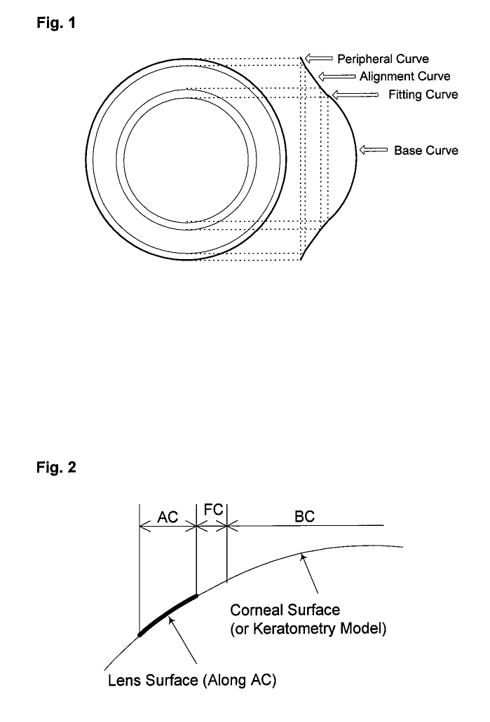

The Orthokeratology Lens has four zones. A Base Curve zone for optical properties, a Fitting Curve zone which provides the proper positioning of the Base Curve to the apex of the eye, an Alignment Curve zone which allows the lens to comfortably fit the eye, and a Peripheral Curve zone that provides edge lift and tear exchange. These zones are illustrated in FIG. 1.

Default Design: The default design specifies the widths of these curves and is given in Table 1:

TABLE 1
Default Curve Widths

| | | |
|---|---|---|
| Base Curve Zone | BC | 6.2 mm |
| Fitting Curve Zone | FC | 0.5 mm |
| Alignment Curve Zone | AC | 1.2 mm |
| Peripheral Curve Zone | PC | 0.5 mm |
| Total Diameter | DIAM | 10.6 mm |

The fitter will be able to adjust any or all of the default widths to meet the specific requirements for the patient.

### Defaults for the Curve Transitions—Fillets

In addition to the widths, each zone will be smoothly transitioned to its neighbor. The preferred method is by use of a fillet curve. These curves are critical to the performance of the lens. Table 2 specifies default values.

TABLE 2
Default Curve Transitions

| | | |
|---|---|---|
| Base Curve to Fitting Curve | BC-FC | 0.05 mm |
| Fitting Curve to Alignment Curve | FC-AC | 0.05 mm |
| Alignment Curve to Peripheral Curve | AC-PC | 0.30 mm |

A fillet curve is calculated by scribing a circle which is tangent to each of the adjoining curves at the point described by traversing the distance given in this table along each of the original curves.

Any other mathematically valid smoothing technique can be used to blend the adjoining zones.

### Measure the Cornea:

### Topographic Data (The “Best-Fit” Shape)

A topographic map that yields either elevation data or slope data from the apex of the cornea out to a distance no less than the outermost width of the Alignment Curve Zone is needed. Smaller samplings could be used, but the alignment curve would then be based on extrapolated data, similar to the Keratometer reading assumption below.

The data from the topographic map is used to construct a “Best-Fit” shape to be used as a reference model for calculating the concave surface of the contact lens. The “Best-Fit” shape can be an Ellipsoid or any other mathematically defined three-dimensional shape that is the closest match to the measured corneal surface. A rotationally symmetric contact lens can be designed to be fit onto any portion of the “Best-Fit” Shape. Rotationally symmetric contact lenses are typically fit onto spherical corneas. A non-rotationally symmetric contact lens can be designed to be fit onto any portion of the “Best-Fit” Shape. Non-rotationally symmetric contact lenses are typically fit onto toric (astigmatic) corneas. Non-rotationally symmetric contact lenses are also fit on diseased corneas, such as Keratoconus, or on Post-Surgical corneas. If a “Best-Fit” shape cannot be mathematically determined, the Topographical Data will be used directly to design the contact lens.

Keratometry Reading: If a corneal topographer is not available, a standard Keratometer reading can be used to approximate the curvature of the eye. The Keratometer readings would be used to calculate an approximation of the “Best-Fit” shape.

### Select Alignment Curve—Radius and Position

The alignment curve should match to the eye surface. THE “BEST-FIT” SHAPE

The Alignment Curve is determined by sampling the elevation data of the “Best-Fit” shape in the region where the Alignment Curve will fit, and applying a mathematical formula, such as a least squares fitting algorithm, to determine the best fit circle that can be scribed along that data. The radius of this circle is used for the Alignment Curve Radius.

The Alignment Curve Zone, instead of being a spherical radius, could be a series of spherical curves or a series of non-spherical mathematically defined shapes that correspond to the “Best-Fit” shape determined by the Topographic Data. FIG. 2 illustrates the alignment curve graphically.

### Select Peripheral Curve—Radius and Position

Peripheral Curve is generally the same for all lenses.

The peripheral curve is chosen to lift the edge of the lens away from the surface of the cornea to provide tear exchange and to help with lens removal. Any mathematically defined curve can be used as long as it achieves the correct edge lift. The default radius of the Peripheral Curve is shown Table 3.

TABLE 3
Peripheral Curve Default

| | | |
|---|---|---|
| Peripheral Curve | PC | 12.0 mm |

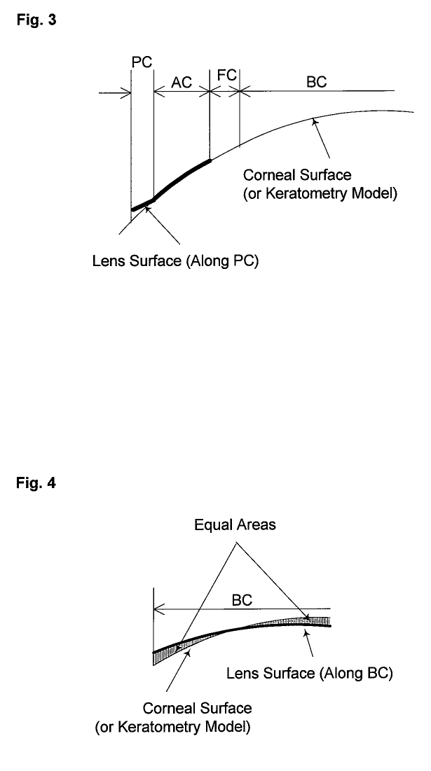

The different curves are also illustrated in FIG. 3.

### Select Base Curve—Radius Only

The radius of the Base Curve zone is chosen to achieve the “End Result”. “End Result” implies that the curvature of the Base Curve zone should be of the same curvature as required by the eye to give good vision. The assumption is that the treated eye will not match perfectly to the back of the lens, but instead will only approach the curvature, indicates that the lens should be constructed in a way that is close to the desired end result, but with a small additional flattening, or steepening, beyond the exact result desired. It is further assumed that in addition to correcting the refractive power error, the End Result for the treated eye will correct as much other existing optical aberration as possible. The End Result can be achieved for either a Myopic (Nearsighted) Eye or a Hyperopic (Far Sighted) Eye.

Select base Curve-Position Only

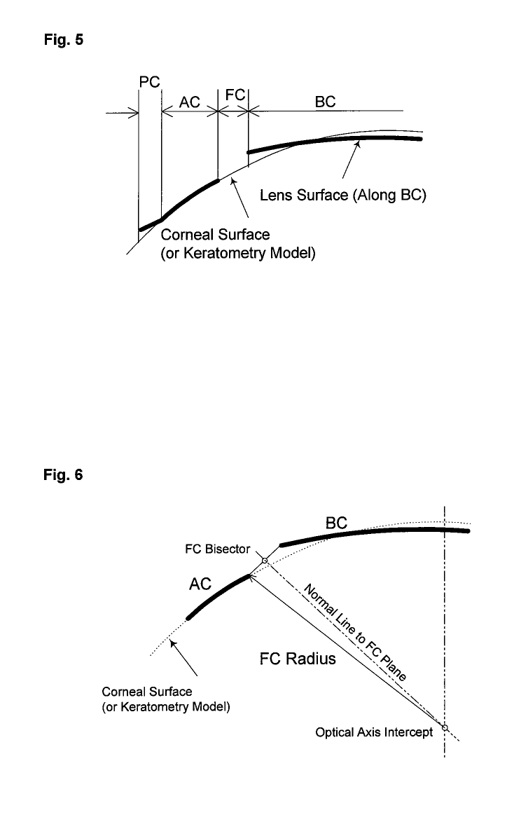

It is generally assumed that the surface of the eye has a constant surface area. The tissue of the cornea cannot be stretched or compressed; it can only be bent or reshaped. There are several methods to calculate the position of the Base Curve zone in relation to the cornea. Methods include calculating Constant Surface area, calculating Constant Arc Length, and calculating Constant Volume. Another method to determine the position of the Base Curve zone is to use a ratio of elevation change vs. change in Refractive Correction. Base curve is illustrated in FIG. 4.

### Position the Base Curve

The positioning of the Base Curve can be to provide either apical clearance on the cornea or to push into the center of the cornea. Generally it would be expected to have apical clearance on a lens for Hyperopic correction and to have apical push on a lens for myopic correction; however the lens fitter can choose any type of position determined by the overall optical characteristics of the individual patient.

Generally, for Hyperopic correction greater apical clearance would be provided in the central portion of the cornea, while for Myopic correction the apical clearance would be greater in the mid-periphery area of the cornea to accommodate the approximate amount of expansion of corneal tissue caused by the addition of the acylation agents depending upon the type of correction indicated for each individual cornea.

Once the Base Curve is placed in this position relative to the cornea, or “Best-Fit” shape, the sagittal depth values at the endpoints of the Base Curve are known. See FIG. 5.

### Determine Required Fitting Curve—Radius and Position

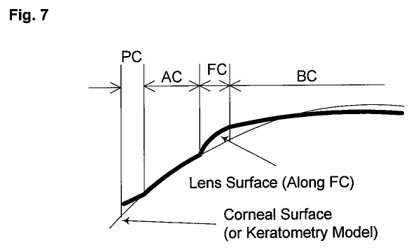

Since the (x,y) coordinates of the Fitting Curve are determined by the inner end of the Alignment Curve, and the outer end of the Base Curve, these can be used to create a line between the two points. This line is bisected, a midpoint is found, and the slope is determined. Negating and inverting the slope yields a line perpendicular to the Fitting Curve line. This perpendicular line is extended from the bisection point until it crosses the optical axis, this intersection point is noted. The radius from this intersection point to either endpoint of the Fitting Curve is determined, and this value becomes the Fitting Curve Radius. FIG. 6. FIG. 7 illustrates the various curves.

The orthokeratology lenses are preferably designed to gradually reshape the corneal tissue utilizing a mechanical pressure of the eyelid and a hydraulic pumping action of liquid tears, either natural or artificial.

Designed orthokeratology lenses are placed on the eyes before chemical treatment, during the process of chemical treatment or following chemical treatment to distribute the chemically treated tissue to achieve acceptable correction of myopia, hyperopia, or astigmatism. The lens being worn for time periods necessary to achieve stable tissue distribution.

In the case of myopia, acylation agents intended to increase net negative charge are applied to a selected circumferential ring on the periphery of the cornea to induce controlled peripheral stromal swelling and subsequent central cornea flattening. This non-surgical treatment can be used to correct myopia by flattening the cornea and reducing the diopters power of the central cornea. However, this treatment can be better controlled by the application of a designed orthokeratology lens to distribute (or redistribute) corneal tissue to predetermined regions of the cornea (as predetermined by corneal topography).

In the case of myopia, a device for applying the acylating agent to the corneal surface is often used. In some embodiments, the device is composed of a series of concentric circles. The center of the concentric circles is solid and is seated on the corneal apex, preventing exposure of the central cornea. An intermediate concentric circle is open to the surface of the cornea allowing exposure of this surface only to the acylating agent. The outer circle is also solid and seated firmly on the corneal surface preventing exposure of the corneal surface to the acylating agent. The width of the intermediate concentric circle can be adjusted to allow exposure of the corneal surface to predetermined widths of the acylating agent. Thus, a ring of predetermined width can be formed on the corneal surface for specific therapeutic applications. The exposed corneal tissue is generally a peripheral ring, approximately 2 mm in diameter near the limbus of the corneal surface.

In one design, a port is fabricated fitting the end of a 1.0-2.5 cc syringe. Acylation solution is injected into the open ring through this delivery port to treat the exposed tissue surface. The acylating agent is also removed using this port and rinse solutions applied to remove unbound dye or stain. The extent of tissue treatment is dependent on the concentration of the acylating agent, exposure time, and the pH of the exposed tissue.

Other configurations for delivery devices can be fabricated to treat predetermined regions of the cornea surface and are used in other embodiments of the invention. For example, a dry sponge, pre-dosed with an appropriate amount of acylating agent is fabricated to specific dimensions such that when the dry, pre-dosed sponge is wet, the chemical agent is delivered to the desired exposed tissue surface. The dry, pre-dosed sponge is fabricated in the form of a thin ring. The ring is then placed in a delivery device. Fluid is then applied to the ring causing it to wet and instantly deliver the pre-dosed acylating agent to the exposed tissue surface to form an exposure ring in the same dimensions as the delivery ring. The delivery ring may be fabricated in different dimensions, thickness and diameter to treat the corneal tissue.

In the case hyperopia, the treatment is generally directed to the central cornea. Although this can be accomplished without the use of a specific treatment device, a treatment device can be used to target the treatment to the central cornea. Non-limiting examples of applicators for use as treatment devices for applying solutions to the central corneal surface are described in provisional application 61/064,731, filed Mar. 24, 2008, and entitled “APPARATUS TO IMPROVE LOCALIZED CONCENTRATION OF FLUIDS IN OCULAR ENVIRONMENTS” by Bruce DeWoolfson and Michael Luttrell. Other treatment devices may also be used, however, and the invention is not limited to using a particular treatment device.

Astigmatism may also be treated in a similar fashion as described for myopia or hyperopia, but in this case the area of treatment may not be limited to either the central cornea or the periphery.

The features and other details of the invention will now be more particularly described and pointed out in the following examples describing preferred techniques and experimental results. These examples are provided for the purpose of illustrating the invention and should not be construed as limiting.

### EXAMPLES

### Example 1

### Corneal Reshaping-Treatment of Myopia

This preliminary study was conducted at Dartmouth-Hitchcock Medical Center, Department of Surgical Research, as previously described in DeVore and DeVore, US2005/0106270. Porcine eyes were procured from a local slaughterhouse, positioned in a device to stabilize the eye and subjected to topographical evaluation using the Optikon 2000 system. The corneal surface was dried using sterile gauze and then wetted with drops of buffer solution. The wetted eyes were again dried and exposed again to the same solution. Then a peripheral ring around the circumference of the corneal surface, slightly away from the limbus and the central cornea, was carefully treated by adding drops of buffer containing the active agent, a 20 mg/ml solution of glutaric anhydride.

The eyes were then reexamined topographically and photos taken. Following evaluation, the eyes were placed in OptiSol for storage pending additional evaluations. Three eyes were treated using this protocol. In two eyes the active agent at 20 mg/mL was applied to a ring around the corneal periphery. The exposure width was approximately 1 mm. In one eye the active agent at 20 mg/mL was applied to a 2 mm diameter area on the apex of the central cornea. The exposure time was 1 minute. All eyes were then washed with neutral pH phosphate buffer.

Topographical evaluation showed that treatment of the periphery of the cornea with the active agent reduced corneal power of porcine eyes by more than 2 diopters. Treatment of the central cornea increased the refractive power by about 0.7 diopters. All eyes appeared clear by visual examination.

TABLE 4
Corneal Power as Measured by Topographical Mapping

| Animal Number | Pre-treatment Power (D) | Post-treatment Power (D) |
|---|---|---|
| #1-central cornea | 40.6 | 41.3 |
| #2-peripheral cornea | 39.5 | 37.4 |
| #3-peripheral cornea | 43.6 | 40.9 |

These results demonstrate that careful treatment of the peripheral corneal surface can result in significant central corneal flattening. Treatment of the central cornea resulted in minor steepening. It is believed that these effects result from controlled hydration of the treated surface.

This simple technique may revolutionize methods used to treat refractive errors. Treatment of areas in the central cornea appears to result in corneal steepening thus providing a simple method to treat hyperopia. Treatment of selective areas of the corneal surface may furthermore be effective in treating astigmatism.

### Example 2

### In Vivo Cat Model

This study was conducted at Dartmouth-Hitchcock Medical Center, Department of Surgical Research, and was approved by IACUC, as previously described in DeVore and DeVore US2005/0106270. Two cats were treated with the active agent, glutaric anhydride. Treatment was applied to the right eye (OD) while the contralateral eye (OS) served as a control. Buffer solution (0.02M disodium phosphate solution at pH 9.0) was first applied to the corneal surface. This was immediately followed by application of a solution of glutaric anhydride in disodium phosphate into a peripheral ring of a corneal mold placed on the corneal surface. The mold provided a tight seal to prevent migration of the active agent to the central cornea. Two treatment applications were provided at Day 1 and Day 7. The dosage of the active agent was 50 mg/mL.

Eyes were examined for another 7 days following the second treatment. Results from topographical evaluation show that refractive power (D) of the treated eye for Cat 1 reduced from 43.65 to 38.88 (4.77 Diopters). Results for Cat 2 showed a reduction from 42.83 to 40.68 (2.2 Diopters). Optical examinations, including slit-lamp biomicroscopy and Shiotz tonometry, showed no differences between treated and control eyes 7 days following the second treatment.

TABLE 5
Corneal Power (Diopters) as Measured by Topographical Mapping

| Animal Number | Average Pre-treat (D) | Average Post-treat (D) |
|---|---|---|
| Cat 1 | 43.65 | 38.88 |
| Cat 2 | 42.83 | 40.68 |

These results appear to confirm preliminary studies showing that the application of a specific active agent can reduce the curvature of the central cornea.

### Example 4

### Treatment of Central Cornea to Increase Diopter Power

This study was conducted at Dartmouth-Hitchcock Medical Center, Department of Surgical Research, and was approved by IACUC. One cat was treated with the active agent, glutaric anhydride. Treatment was applied to the left eye (OS) while the contralateral eye (OD) served as a control. Buffer solution (0.02M disodium phosphate solution at pH 9.0) was first applied to the corneal surface. This was immediately followed by application of a solution of glutaric anhydride in disodium phosphate into the central well of a corneal mold placed on the corneal surface. The mold provided a tight seal to prevent migration of the active agent to the peripheral cornea. Two treatment applications were provided at Day 1 and Day 6. The dosage of the active agent was 50 mg/mL.

Eyes were examined for another 7 days following the second treatment. Results from topographical evaluation show that refractive power (D) of the treated eye for Cat 1 increased from 40.15 to 41.47 (1.32 Diopters). Optical examinations, including slit-lamp biomicroscopy and Shiotz tonometry, showed no differences between treated and control eyes 6 days following the second treatment.

### Example 5

### Treatment of Enucleated Porcine Eyes

Whole, fresh porcine (pig) eyes were obtained from a local abattoir and immediately placed in Optisol GS preservation solution. The whole eye was placed in a holder allowing the corneal surface to be exposed. A 7 mm trephine was used to cut through the epithelium and penetrate the superficial corneal tissue. The corneal surface was then flooded with 0.2 M disodium phosphate solution, pH 9.0. After 1 minute, the surface of the cornea was dried using an absorbent wipe (KimWipe). The corneal surface was immediately treated with 0.2 M disodium phosphate solution, pH 9.0, containing 50 mg/mL of glutaric anhydride. After 1 minute of exposure, the cornea was flushed with phosphate buffered saline, pH 7.2.

The surface of the cornea was inspected and the corneal curvature examined and compared to untreated eyes. A white ring was observed at the trephine impression, even after several days. The central corneal surface was clearly depressed or flattened compared to untreated eyes. The application of glutaric anhydride to a trephined peripheral ring of a pig cornea produced obvious flattening of the central cornea. Therefore, this technique provides a simple, non-surgical method for treating myopia by inducing swelling in defined ring on the corneal periphery, thereby causing flattening of the central cornea.

### Example 6

### Treatment of Hyperopic Patient

A mildly hyperopic subject was treated with drops of Propacaine HCl followed by application of a pretreatment buffer, pH 8.5. After approximately 30 seconds, a solution containing 3 mg/0.6 mL glutaric anhydride was applied to the central cornea using an applicator device. The central cornea was then flushed with buffer solution.

Follow-up examinations demonstrated a 0.8 diopter improvement in hyperopia, without any lens wear.

### Example 7

### Treatment of Hyperopia

### A. Corrective Orthokeratology Lens Wear Before Acylation Treatment

A subject is given a complete visual examination and shown to exhibit, e.g., 3 diopters of hyperopia. A corrective orthokeratology lens is produced and fitted to the subject. After overnight lens wear for approximately 2 weeks, the subject's hyperopia is corrected and the subject is treated with an acylation agent, e.g., glutaric anhydride, to enhance correction of hyperopia achieved by the overnight corrective orthokeratology lens. The subject is treated with drops of Propacaine HCI followed by application of slightly alkaline a pretreatment buffer, e.g., pH 8.5. After approximately 30 seconds, a solution containing acylating agent is applied to the central cornea using an applicator device. The central cornea is then flushed with buffer solution. Follow-up examinations are conducted to confirm immediate maintenance of correction.

### B. Corrective Orthokeratology Lens Wear Before and Immediately Following Acylation Treatment

A subject is given a complete visual examination and show to exhibit, e.g., 3 diopters of hyperopia. A corrective orthokeratology lens is produced and fitted to the subject. After overnight lens wear for approximately 2 weeks, the subject's hyperopia is corrected and the subject is treated with an acylation agent, e.g., glutaric anhydride, to enhance correction of hyperopia achieved by the overnight corrective orthokeratology lens. The subject is treated with drops of Propacaine HCl followed by application of a slightly alkaline pretreatment buffer, e.g., pH 8.5. After approximately 30 seconds, a solution containing 3 mg/0.6 mL acylating agent is applied to the central cornea using an applicator device. The central cornea is then flushed with buffer solution. Follow-up examinations are conducted to confirm immediate maintenance of correction. Corrective orthokeratology lenses are continued for approximately 2 weeks after acylation treatment. Maintenance of vision correction is evaluated during routine examinations at 3 month intervals.

### C. Corrective Orthokeratology Lens Wear Following Acylation Treatment.

A subject is given a complete visual examination and show to exhibit, e.g., 3 diopters of hyperopia. The subject is treated with drops of Propacaine HCl followed by application of a slightly alkaline pretreatment buffer, e.g., pH 8.5. After approximately 30 seconds, a solution containing 3 mg/0.6 mL acylating agent is applied to the central cornea using an applicator device. The central cornea is then flushed with buffer solution. A corrective orthokeratology lens specifically designed for the subject is than worn for approximately 2 weeks. Lens wear is discontinued after maintenance of vision correction.

Although the present invention has been described with reference to preferred embodiments, one skilled in the art can easily ascertain its essential characteristics and without departing from the spirit and scope thereof, can make various changes and modifications of the invention to adapt it to various usages and conditions. Those skilled in the art will recognize or be able to ascertain using no more than routine experimentation, many equivalents to the specific embodiments of the invention herein. Such equivalents are intended to be encompassed in the scope of the present invention.

All references, including patents, publications, and patent applications, mentioned in this specification are herein incorporated by reference in the same extent as if each independent publication, patent or patent application was specifically and individually indicated to be incorporated by reference.

We claim:

1. A method of treating the refractive error of an eye, comprising:
a first step comprising placing a treatment device on the cornea of the eye, wherein the treatment device is configured to control the area of application of a treatment to corneal tissues of the eye;
a second step comprising applying to the corneal tissues a treatment that induces swelling of the corneal tissues in the area determined by the treatment device;
a third step comprising removing the treatment device; and
a fourth step comprising placing an orthokeratology lens that has been configured to correct the refractive error and, optionally, any additional optical errors, of the corneal tissues on the cornea to provide a controlled redistribution of the treated corneal tissues;
thereby treating the refractive error of the eye.

2. The method of claim 1, wherein the method further comprises placing an orthokeratology lens on the cornea for a period of time sufficient to improve the refractive error of the eye and removing the orthokeratology lens during placement of the treatment device on the cornea.

3. The method of claim 1, wherein the eye has not been treated with an orthokeratology lens prior to the placement of the treatment device.

4. The method of claim 1, wherein the treatment comprises first applying a buffer solution for a period of time sufficient to bring the pH of the corneal tissue to between pH 7.5 and 9.5 and second applying an acylation reagent.

5. The method of claim 4, wherein the acylation reagent is selected from the group consisting of sulfonic acids, anhydrides, sulfonyl chlorides, and acid chlorides.

6. The method of claim 5, wherein the acylation reagent is glutaric anhydride.

7. The method of claim 1, wherein the eye is myopic and the treatment device is configured to control the application of the treatment to the periphery of the corneal tissues of the eye.

8. The method of claim 1, wherein the eye is hyperopic and the treatment device is configured to control the application of the treatment to the central area of the corneal tissues of the eye.

9. The method of claim 1, wherein the eye is astigmatic and the treatment device is configured to control the application of the treatment to those areas of the corneal tissue that have refractive errors or other optical errors.

10. A method of treating the refractive error of an eye, comprising
placing on the cornea an orthokeratology lens that has been configured to correct the refractive error and, optionally, any additional optical errors, of the corneal tissues, wherein the orthokeratology lens comprises a septum that permits access to the corneal tissues without removal of the lens;
applying through the septum of the orthokeratology lens a first treatment to the corneal tissues, wherein the first treatment comprises a buffer solution to adjust the pH of the corneal tissue to between pH 7.5 and 9.5; and
applying through the septum of the orthokeratology lens a second treatment to the corneal tissues, wherein the second treatment comprises an acylation reagent that induces swelling of the corneal tissues;
thereby treating the refractive error of the eye.

11. The method of claim 10, wherein the acylation reagent is selected from the group consisting of sulfonic acids, anhydrides, sulfonyl chlorides, and acid chlorides.

12. The method of claim 11, wherein the acylation reagent is glutaric anhydride.

13. The method of claim 10, wherein the eye is hyperopic.

14. The method of claim 10, wherein the eye is astigmatic.

15. A method of treating the refractive error of an eye, comprising:
applying to the corneal tissues a treatment that induces swelling of the corneal tissues; and
placing an orthokeratology lens that has been configured to correct the refractive error and, optionally, any additional optical errors, of the corneal tissues on the cornea to provide a controlled redistribution of the treated corneal tissues;
thereby treating the refractive error of the eye.

16. The method of claim 15, wherein the treatment that induces swelling of the corneal tissues is an acylation reagent.

17. The method of claim 16, wherein the acylation reagent is glutaric anhydride.

18. The method of claim 15, wherein the eye is hyperopic.

19. The method of claim 15, wherein the eye is myopic.

20. The method of claim 15, wherein the eye is astigmatic.
